(19) United States
(12) Patent Application Publication
(10) Pub. No.: US 2025/0207326 A1
(43) Pub. Date: Jun. 26, 2025

(54) IMPROVEMENTS IN BIOMASS DELIGNIFICATION

(71) Applicant: SixRing Inc., Calgary (CA)

(72) Inventors: Alejandra ENRIQUEZ, Calgary (CA); Andrew CORBETT, Calgary (CA); Matthew DEWIT, Calgary (CA); Sergey TALISVEIBER, Calgary (CA); Markus WEISSENBERGER, Calgary (CA)

(21) Appl. No.: 18/750,761

(22) Filed: Jun. 21, 2024

(30) Foreign Application Priority Data
Dec. 21, 2023 (CA) 3224383

(51) Int. Cl. D21C 3/04; C08B 15/08

(52) U.S. Cl. CPC D21C 3/04; C08B 15/08

(57) ABSTRACT

A method for obtaining alpha-cellulose in a purity of above 85%, where said method comprises the following steps:
Step 1: providing a biomass feedstock comprising: cellulose; hemicellulose; and lignin;
Step 2: exposing the biomass feedstock to a delignification step performed using a modified Caro's acid creating a reaction mixture, wherein said delignification is carried out at a temperature ranging 20-40° C. for a period of time sufficient to allow the modified Caro's acid to delignify said lignocellulosic biomass and yield: a remaining solids portion having a kappa number of less than 10; and a liquid stream;
Step 4: removing said liquid stream comprising depolymerized lignin and depolymerized hemicellulose from the resulting reaction mixture;
Step 5: recovering said remaining solids portion comprising high purity cellulosic portion.

### FIELD OF THE INVENTION

The present invention is directed to a process to isolate alpha cellulose, more specifically and preferably, the process generates alpha cellulose from lignocellulosic biomass, where the alpha cellulose thus obtained is at least 85% pure.

### BACKGROUND OF THE INVENTION

The first step in paper production and most energy-intensive one is the production of pulp.

Notwithstanding water, wood and other plant materials used to make pulp contain three main components:
cellulose fibers, lignin, and hemicellulose. Pulping has a primary goal to separate the fibers from the lignin. Lignin is a three-dimensional polymer which figuratively acts as a mortar to hold all the fibers together within the plant. Its presence in finished pulp is undesirable and adds nothing to the finished product. Pulping wood refers to breaking down the bulk structure of the fiber source, be it chips, stems, or other plant parts, into the constituent fibers. The cellulose fibers are the most desired component when papermaking is involved. Hemicellulose is a shorter branched carbohydrate polymer consisting of various sugar monomers which form a random amorphous polymeric structure. The presence of hemicellulose in finished pulp is not as critical to paper rigidity as cellulose is. This is also true for biomass conversion. The challenges are similar. Only the desired outcome is different. Biomass conversion would have the further breakdown to monosaccharides or other derived molecules as a desired outcome while a pulp & paper process normally stops right after lignin dissolution.

There are two main approaches to preparing wood pulp mechanical treatment and chemical treatment. Mechanical treatment or pulping generally consists of physically tearing the wood chips apart and, thus, tearing cellulose fibers apart in an effort to separate them from each other. The shortcomings of this approach include: broken or damaged cellulose fibers, thus shorter fibers; and lignin contamination or residue on the cellulose fibers, thus introducing or leaving behind impurities in the final product. This process also consumes large amounts of energy and is capital intensive due to the high pressure, corrosive chemicals, and heat required. There are several approaches or processes included in chemical pulping. These are generally focused on the degradation of the lignin and hemicellulose into their molecular constituents. These now degraded components are separated from the cellulose fibers by washing the latter without damaging the cellulose fibers. The chemical process is currently energy intensive as well, as high amounts of heat are typically required; and, in many cases, also require agitation or mechanical intervention adding inefficiencies and costs to the process. There exists pulping or treatment methods which combine, to a various extent, the chemical aspects of pulping with the mechanical aspects of pulping. To name a few, one must consider including thermomechanical pulping (also commonly referred to as TMP), and chemithermomechanical pulping (CTMP). Through a selection of the advantages provided by each general pulping method, the treatments are designed to reduce the amount of energy required by the mechanical aspect of the pulping treatment. This can also directly impact the strength or tensile strength degradation of the fibers subjected to these combination pulping approaches. Generally, these approaches involve a shortened chemical treatment (compared to conventional exclusive chemical pulping) which is then typically followed by mechanical treatment to separate the fibers.

The most common process to make pulp for paper production is the kraft process. In the kraft process, wood chips are converted to wood pulp which is almost entirely pure cellulose fibers. The multi-step kraft process consists of a first step where wood chips are impregnated/treated with a chemical solution called white liquor: a strong alkaline solution comprising sodium hydroxide and sodium sulfide.

This is done by soaking the wood chips and then heating them with steam. This step swells the wood chips and expels the air present in them and replaces the air with the white liquor. Once the wood material has been soaked in the various chemical solutions, they undergo cooking. To achieve delignification in the wood chips, the cooking is carried out for several hours at temperatures reaching up to 176° C. At these temperatures, the lignin and hemicellulose degrade to yield water soluble fragments. This produces black liquor, a resultant by-product from the kraft process. It contains water, lignin residues, hemicellulose and inorganic chemicals. The remaining cellulosic fibers are collected and washed after the cooking step. However, the delignification is not quantitative and these cellulosic fibers (called brownstock due to its brown colour) still contain about 5% lignin. For paper production, these fibers need to undergo a subsequent bleaching step to remove the remaining lignin in the pulp. This bleaching process requires chemicals such as hydrogen peroxide, sodium dithionite, chlorine, chlorine dioxide and others, which have attracted significant criticism for its associated environmental damage.

Dissolving pulp is special grade of pulp with high purity that is widely used in textile production industry to get rayon staple for high-quality fabrics. It is also used in the paper production industry as an additive to binders or as a blend with mechanical pulps, as well as in the pharmaceutical industry as precursors to other molecules of interest (i.e., cellulose derivatives, microcrystalline cellulose, etc.). Comparing with other types of pulp, dissolving pulp is rarely intended for papermaking. A high-purity dissolving pulp is characterized by a high cellulose content and a low content of hemicelluloses (<5% w/w), lignin and extractives. The purity of the cellulose is the prime factor which differentiates paper-grade pulps from dissolving-grade pulps.

The production of regenerated cellulosic fibres, such as viscose, modal and lyocell, is based mainly on the use of dissolving pulp as raw material. The main processes to produce dissolving pulp are the sulfite process and pre-hydrolysis kraft pulp process. Wood-derived cellulose accounts for about 85-88% of dissolving pulp, while the rest of the market is based on cotton linters. Enzymatic processes have emerged as an alternative to conventional chemical routes in the production of dissolving pulp, in terms of energy efficiency, reagent consumption and pulp yield. The two main characteristics of a dissolving pulp are the cellulose purity and the molecular weight, both of which can be controlled with the aid of enzymes. A purification process for paper-grade kraft pulp has been proposed, based on the use of xylanases in combination with hot and cold caustic extraction, without the conventional pre-hydrolysis step before kraft pulping.

Regenerated cellulosic fibre is considered a sustainable alternative to cotton and synthetic textile fibres. These are commonly produced from dissolving pulp. Although the most common end-use of dissolving pulp is in the production of viscose fibres, alternative applications include the production of cellophane and cellulose derivatives, mainly esters and ethers. Cellulosic materials can be employed in a multitude of industries including pharmaceuticals, food and beverage, ceramics, construction, and so on.

The pulping processes in use today for the production of dissolving wood pulp are the pre-hydrolysis kraft (PHK) and the acid sulphite cooking processes. The kraft-based pulping process has overtaken the sulphite process to become the predominant process to produce dissolving wood pulp. In part because it is less sensitive to the extractives content in the wood, allowing both hardwood and softwoods to be used.

First, a pre-hydrolysis step at an acidic pH and high temperature and pressure to remove a large portion of hemicelluloses present prior to subjecting the remaining pulp to an alkaline kraft pulping stage. It is incumbent on operators to optimize the parameters involved in both the pre-hydrolysis step and the kraft delignification step, in terms of temperature, pressure and pH so as to be able to obtain the highest yield in cellulose while removing hemicelluloses and lignin in subsequent steps. The severe conditions under which those two steps are carried out lead to a yield ranging from 30 to 35% based on the biomass used.

Another step used when a high purity cellulose is sought is cold caustic extraction. This involves high fibre swelling mainly aimed at dissolving hemicelluloses. Cold caustic extraction is generally carried out at a temperature ranging from 20-40° C. in 8-10% NaOH. It has been reported that the high concentration of sodium hydroxide in the cold caustic extraction can, in some cases, lead to a higher proportion of cellulose polymorph II which is less reactive that cellulose polymorph I.

International patent application WO2012070072A2 discloses a process for obtaining an alpha-cellulose with high molecular weight and purity from lignocellulosic material. It states that the lignocellulosic raw material is treated by contacting it with high pressure steam at temperature in the range 190° C.-200° C. for at least 2 minutes to solubilize the hemicellulose fraction. The undissolved fibrous organic biomass is washed with hot soft water to give the pretreated lignocellulosic material. The pretreated lignocellulosic material is pulped using sulfite, alkali and anthraquinone at a temperature of at least 120° C. and holding time of at least 15 minutes for solubilizing lignin component by converting into lignosulfonate. The washed and screened pulp is bleached, washed to obtain the pulp containing at least 92% alpha-cellulose having high molecular weight in the range of 10,00,000-25,00,000. Such alpha-cellulose with high molecular weight and purity is suitable for converting into biodegradable derivatives.

U.S. Pat. No. 5,139,617 discloses a process for the production of a hemicellulose hydrolysate and special pulp from a material containing lignocellulose through two steps, the first step comprising the hydrolysis of hemicelluloses into simple sugars and the second step the dissolving of lignin for liberating cellulose fibres. The process is said to have the following advantages: increase yield of special pulp; the process after the pre-hydrolysis is simplified, which decreases the cost of investment; easier delignification in the cooking step decreases the need of bleaching, thus improving the production economy and reducing the emission of chlorinated compounds from the bleaching; the oxygen or peroxide step after the cooking is extremely efficient as compared with that of the pre-hydrolysis sulphate process; and small-scale production is economically more interesting because it is possible to operate in connection with an existing sodium-based sulphite pulp mill without any appreciable additional investments. The patent further states that excellent results can be obtained by effecting the lignin dissolving after the pre-hydrolysis by an alkaline neutral sulphite cooking with anthraquinone or a derivative thereof as a catalyst.

Canadian patent CA 2,801,986 C discloses a process for producing microcellulose comprising a) acidifying fibrous cellulosic material, b) washing the acidified cellulosic material, c) optionally dewatering the washed cellulosic material, and d) hydrolyzing the washed or washed and dewatered cellulosic material under acidic conditions at a temperature of at least 120° C. and at a consistency of at least 8% on dry weight of the cellulose.

In light of the state of the art, there is still a need to develop a process to obtain alpha cellulose at lower processing cost as well as reproducible manner applicable in small- or large-scale production sites. Accordingly, the resulting cellulose obtained from such a process is referred to as dissolving pulp and can be employed in the production of textiles of various other materials as a replacement to other textile sources such as cotton.

It has been surprisingly discovered that delignifying a lignocellulosic biomass material with a modified Caro's acid at low temperatures has a significant bearing on the amount of alpha cellulose which can be extracted from the biomass. Indeed, despite the seemingly harsh acidic conditions the delignification reaction exposes the biomass material to, it seems that the temperature of the reaction has a profound impact on the morphology of the cellulose thusly generated.

When making dissolving pulp, the cellulose in the biomass must be substantially free of lignin as well as hemicellulose. Moreover, while native cellulose exists in both alpha and beta forms, it is the alpha cellulose which is desirable to make dissolving pulp. Should the concentration of beta cellulose be too high the dissolving pulp will be of poor quality. Hence, it is highly desirable to develop a process which uses biomass to yield high amounts of alpha cellulose with high purity.

Advantageously, a process to obtain alpha cellulose would help in the production of, among other things, dissolving pulp. Dissolving pulp is used to produce cellulosic materials such as acetate, cellophanes, and rayons. Dissolving pulp requires high purity cellulose to be useful in such applications. Additionally, dissolving pulp is the starting material for many other products such as microcrystalline and nanocrystalline cellulose.

### SUMMARY OF THE INVENTION

According to a first aspect of the present invention, there is provided a process for obtaining alpha-cellulose with high molecular weight and purity suitable for converting into derivatives.

According to another aspect of the present invention, there is provided a method for obtaining alpha-cellulose in a purity of above 85%, where said method comprises the following steps:
Step 1: providing a biomass feedstock comprising: cellulose; hemicellulose; and lignin;
Step 2: exposing the biomass feedstock to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
   wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
   wherein said delignification is carried out at a temperature ranging 20-40° C. for a period of time sufficient to allow the modified Caro's acid to delignify said lignocellulosic biomass and yield: a remaining solids portion having a kappa number of less than 10; and a liquid stream;
Step 4: removing said liquid stream comprising depolymerized lignin and depolymerized hemicellulose from the resulting reaction mixture;
Step 5: recovering said remaining solids portion comprising high purity cellulosic portion. Preferably, said temperature ranges between 25 and 35° C.

According to a preferred embodiment of the present invention, Step 4 is followed by:
a step of exposing said remaining solids portion to a caustic composition at a low temperature to generate a caustic mixture comprising said caustic composition, hemicellulose, alpha-cellulose, and beta-cellulose;
followed by a step of allowing sufficient time for said caustic composition to dissolve said hemicellulose and beta cellulose present in said remaining solids portion and yield a high purity cellulosic portion comprising a high 90% of alpha cellulose in a reacted caustic mixture; and
optionally, followed by a step of extracting said dissolved hemicellulose as well as beta-cellulose from said reacted caustic mixture; and
a step of recovering said high purity cellulosic portion.

According to a preferred embodiment of the present invention, the removal of beta-cellulose from said reacted caustic mixture comprises altering the pH of said reacted caustic mixture to a pH between 2-6 and removing the resulting precipitated beta-cellulose therefrom.

According to a preferred embodiment of the present invention, removal of hemicellulose from said reacted caustic mixture comprises adding to said alkali solution a sufficient amount of a solvent consisting essentially of ethanol to precipitate said hemicellulose from said caustic alkali solution, removing the resulting precipitated hemicellulose from the caustic solution. Preferably, the caustic composition is recovered and purified. Preferably, the temperature at which the caustic exposure occurs does not exceed 60° C.

According to a preferred embodiment of the present invention, the cellulose has a fiber length of 100 to 1000 microns. Preferably, said alpha-cellulose accounts for over 70% of the cellulose obtained.

According to a preferred embodiment of the present invention, said delignification step is carried out at a temperature ranging from 25 to 35° C. Preferably, said delignification step is carried out at a temperature ranging from 30 to 35° C.

According to another aspect of the present invention, there is provided a process for the manufacture of alpha cellulose from a delignification of a lignocellulosic biomass by exposure to a modified Caro's acid, said process comprises the steps of:
providing a vessel;
providing a biomass feedstock comprising lignin, hemicellulose and cellulose fibers into said vessel;
allowing said modified Caro's acid to come into contact with said biomass feedstock at a temperature below 40° C. for a period of time sufficient to perform a delignification reaction which yields a remaining solids portion and a liquid portion, said remaining solids portion having a kappa number of less than 10;
optionally, separating said liquid portion from said remaining solids portion, said liquid portion comprising depolymerized lignin;
optionally, exposing said remaining solids portion to a caustic composition at a low temperature to generate a caustic mixture comprising said caustic composition, hemicellulose, alpha-cellulose, and beta-cellulose;
optionally, allowing sufficient time for said caustic composition to dissolve said hemicellulose present in said remaining solids portion and yield:
   a high purity cellulosic portion comprising at least 90% of alpha cellulose;
optionally, extracting said dissolved hemicellulose as well as beta-cellulose from said caustic mixture; and
recovering said a remaining solids portion comprising high purity cellulosic portion.

According to another aspect of the present invention, there is provided a method for obtaining alpha-cellulose in a purity of above 90%, where said method comprises the following steps:
Step 1: providing a biomass feedstock comprising: cellulose; hemicellulose; and lignin;
Step 2: exposing said biomass feedstock to a first acidic composition comprising an acid selected from the group consisting of: mineral acids; organic acids; modified acids; synthetic acids; and combinations thereof; for a first period of time sufficient to dissolve at least 50% of the hemicellulose present in said biomass feedstock;
Step 3: separating and recovering into a first liquid stream comprising dissolved hemicellulose from a remaining lignocellulosic biomass;
Step 4: exposing said remaining lignocellulosic biomass to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
   wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
   wherein said delignification step is carried out at a temperature ranging from 20-40° C. for a period of time sufficient to allow the modified Caro's acid to delignify said remaining lignocellulosic biomass and yield;
a high purity cellulosic portion having a kappa number of less than 10; and
a liquid stream;
Step 4: removing said liquid stream comprising depolymerized lignin and depolymerized hemicellulose from the resulting reaction mixture;
Step 7: recovering said high purity cellulosic portion;
   wherein said high purity cellulosic portion comprises no less than 90% alpha cellulose and no more than 1% lignin and no more than 5% hemicellulose.

According to yet another aspect of the present invention, there is provided a process for the manufacture of alpha cellulose from a delignification of a lignocellulosic biomass by exposure to a modified Caro's acid, said process comprises the steps of:
exposing said biomass feedstock to a first acidic composition comprising an acid selected from the group consisting of: mineral acids; organic acids; modified acids; synthetic acids; and combinations thereof; for a first period of time sufficient to dissolve at least 50% of the hemicellulose present in said biomass feedstock and yield a hemicellulose-depleted biomass;
exposing said a hemicellulose-depleted biomass to a modified Caro's acid to create a reaction mixture at a temperature below 40° C. for a period of time sufficient to perform a delignification reaction which yields:
a high purity cellulosic portion comprising a high 90% of alpha cellulose; and
a liquid portion,
said a high purity cellulosic portion having a kappa number of less than 10; and
optionally, separating said liquid portion from said a high purity cellulosic portion, said liquid portion comprising depolymerized lignin.

Preferably, said modified Caro's acid is selected from the group consisting of: composition A; composition B; composition C; composition D; composition E; composition F; composition G; composition H; composition I; and composition J;

wherein said composition A comprises:
sulfuric acid;
a compound comprising an amine moiety and a sulfonic acid moiety selected from the group consisting of: taurine; taurolidine; taurocholic acid; tauroselcholic acid; tauromustine; 5-taurinomethyluridine and 5-taurinomethyl-2-thiouridine; homotaurine (tramiprosate); acamprosate; taurates; aminoalkylsulfonic acids where the alkyl is selected from the group consisting of C₁-C₅ linear alkyl and C3-C5 branched alkyl; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
   a peroxide; and wherein sulfuric acid and said a carbonyl-containing nitrogenous base compound; are present in a molar ratio of no less than 1:1.

According to another aspect of the present invention, there is provided a method for obtaining beta-cellulose in a yield of ranging up to 50% of all cellulose comprised in a biomass feedstock, where said method comprises the following steps:
Step 1: providing a biomass feedstock comprising: cellulose; hemicellulose; and lignin;
Step 2: exposing the biomass feedstock to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
   wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
   wherein said delignification is carried out at a temperature ranging from 40-70° C. for a period of time sufficient to allow the modified Caro's acid to delignify said lignocellulosic biomass and yield:
a remaining solids portion having a kappa number of less than 10; and
a liquid stream;
Step 4: removing said liquid stream comprising depolymerized lignin and depolymerized hemicellulose from the resulting reaction mixture;
Step 5: recovering said remaining solids portion comprising a high purity cellulosic portion.

According to a preferred embodiment of the present invention, said high purity cellulosic portion comprises between 10 and 30% of beta cellulose. Preferably, said delignification step is carried out at a temperature ranging from 40 to 55° C.

According to a preferred embodiment of the present invention, Step 4 is followed by:
a step of exposing said remaining solids portion to a caustic composition at a low temperature to generate a caustic mixture comprising said caustic composition, hemicellulose, alpha-cellulose, and beta-cellulose;
followed by a step of allowing sufficient time for said caustic composition to dissolve said hemicellulose and beta cellulose present in said remaining solids portion and yield a high purity cellulosic portion; and
optionally, followed by a step of extracting said dissolved beta-cellulose from said reacted caustic mixture wherein said beta-cellulose is at least 50% pure.

According to another aspect of the present invention, there is provided a method for obtaining beta-cellulose in a yield of ranging up to 50% of all cellulose comprised in a biomass feedstock, where said method comprises the following steps:
Step 1: providing a biomass feedstock comprising: cellulose; hemicellulose; and lignin;
Step 2: exposing said biomass feedstock to a first acidic composition comprising an acid selected from the group consisting of: mineral acids; organic acids; modified acids; synthetic acids; and combinations thereof; for a first period of time sufficient to dissolve at least 50% of the hemicellulose present in said biomass feedstock;
Step 3: separating and recovering into a first liquid stream comprising dissolved hemicellulose from a remaining lignocellulosic biomass;
Step 4: exposing said remaining lignocellulosic biomass to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
   wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
   wherein said delignification step is carried out at a temperature ranging from 40-70° C. for a period of time sufficient to allow the modified Caro's acid to delignify said remaining lignocellulosic biomass and yield;
a high purity cellulosic portion having a kappa number of less than 10; and
a liquid stream;
Step 4: removing said liquid stream comprising depolymerized lignin and depolymerized hemicellulose from the resulting reaction mixture;
Step 7: recovering said high purity cellulosic portion;
   wherein said high purity cellulosic portion comprises up to 50% of beta cellulose and no more than 1% lignin and no more than 5% hemicellulose.

Preferably, said high purity cellulosic portion comprises between 10 and 30% of beta cellulose. According to a preferred embodiment of the present invention, said delignification step is carried out at a temperature ranging from 40 to 55° C.

According to preferred embodiment of the present invention, the modified Caro's acid (as disclosed in Canadian patent application 3,128,678) comprises: sulfuric acid; a heterocyclic compound; and wherein sulfuric acid and said a heterocyclic compound; are present in a molar ratio of no less than 1:1. Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. Preferably, the sulfuric acid and heterocyclic compound are present in a molar ratio ranging from 12:1 to 6:1. Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to preferred embodiment of the present invention, the modified Caro's acid (as disclosed in Canadian patent application 3,128,677) comprises: sulfuric acid; a modifying agent comprising a compound containing an amine group; and wherein sulfuric acid and said compound containing an amine group; are present in a molar ratio of no less than 1:1. Preferably, the sulfuric acid and said compound containing an amine group are present in a molar ratio ranging from 28:1 to 2:1. More preferably, the sulfuric acid and compound containing an amine group are present in a molar ratio ranging from 24:1 to 3:1. Preferably, the sulfuric acid and compound containing an amine group are present in a molar ratio ranging from 20:1 to 4:1. More preferably, the sulfuric acid and compound containing an amine group are present in a molar ratio ranging from 16:1 to 5:1. Preferably, the sulfuric acid and compound containing an amine group are present in a molar ratio ranging from 12:1 to 6:1. According to a preferred embodiment of the present invention, the modifying agent is selected in the group consisting of: TEOA; MEOA; pyrrolidine; DEOA; ethylenediamine; diethylamine; triethylamine; morpholine; MEA-triazine; and combinations thereof. According to a more preferred embodiment of the present invention, the modifying agent is TEOA; MEOA; pyrrolidine; DEOA; ethylenediamine; triethylamine.

According to preferred embodiment of the present invention, the modified Caro's acid (as disclosed in Canadian patent application 3,128,676) comprises: sulfuric acid; a modifying agent comprising an alkanesulfonic acid; and wherein sulfuric acid and said alkanesulfonic acid are present in a molar ratio of no less than 1:1. Preferably, said alkanesulfonic acid is selected from the group consisting of: alkanesulfonic acids where the alkyl groups range from C1-C6 and are linear or branched; and combinations thereof. Preferably, said alkanesulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkanesulfonic acid is methanesulfonic acid. Also preferably, said alkanesulfonic acid has a molecular weight below 300 g/mol. Also preferably, said alkanesulfonic acid has a molecular weight below 150 g/mol. Preferably, the sulfuric acid and said alkanesulfonic acid and are present in a molar ratio ranging from 28:1 to 2:1. More preferably, the sulfuric acid and alkanesulfonic acid are present in a molar ratio ranging from 24:1 to 3:1. Preferably, the sulfuric acid and alkanesulfonic acid are present in a molar ratio ranging from 20:1 to 4:1. More preferably, the sulfuric acid and alkanesulfonic acid are present in a molar ratio ranging from 16:1 to 5:1. According to a preferred embodiment of the present invention, the sulfuric acid and alkanesulfonic acid are present in a molar ratio ranging from 12:1 to 6:1.

According to preferred embodiment of the present invention, the modified Caro's acid (as disclosed in Canadian patent application 3,128,675) comprises: sulfuric acid; a substituted aromatic compound; and wherein sulfuric acid and said substituted aromatic compound; are present in a molar ratio of no less than 1:1. Preferably, the substituted aromatic compound comprises at least two substituents. More preferably, at least one substituent is an amine group and at least one of the other substituent is a sulfonic acid moiety. According to a preferred embodiment, the substituted aromatic compound comprises three or more substituent. According to a preferred embodiment of the present invention, the substituted aromatic compound comprises at least a sulfonic acid moiety. According to another preferred embodiment of the present invention, the substituted aromatic compound comprises an aromatic compound having a sulfonamide substituent, where the compound can be selected from the group consisting of: benzenesulfonamides; toluenesulfonamides; substituted benzenesulfonamides; and substituted toluenesulfonamides. Preferably, the sulfuric acid and said substituted aromatic compound and are present in a molar ratio ranging from 28:1 to 2:1. More preferably, the sulfuric acid and substituted aromatic compound are present in a molar ratio ranging from 24:1 to 3:1. Preferably, the sulfuric acid and substituted aromatic compound are present in a molar ratio ranging from 20:1 to 4:1. More preferably, the sulfuric acid and substituted aromatic compound are present in a molar ratio ranging from 16:1 to 5:1. Preferably, the sulfuric acid and substituted aromatic compound are present in a molar ratio ranging from 12:1 to 6:1.

According to preferred embodiment of the present invention, the modified Caro's acid (as disclosed in Canadian patent application 3,128,674) comprises: sulfuric acid; a modifying agent comprising an arylsulfonic acid; and optionally, a compound containing an amine group; wherein sulfuric acid and said a arylsulfonic acid; are present in a molar ratio of no less than 1:1. Preferably, the compound containing an amine group is selected from the group consisting of: imidazole; N-methylimidazole; triazole; monoethanolamine (MEOA); diethanolamine (DEOA); triethanolamine (TEOA); pyrrolidine and combinations thereof. According to a preferred embodiment of the present invention, sulfuric acid and the peroxide are present in a molar ratio of approximately 1:1. Preferably, the sulfuric acid and said arylsulfonic acid and are present in a molar ratio ranging from 28:1 to 2:1. More preferably, the sulfuric acid and arylsulfonic acid are present in a molar ratio ranging from 24:1 to 3:1. Preferably, the sulfuric acid and arylsulfonic acid are present in a molar ratio ranging from 20:1 to 4:1. More preferably, the sulfuric acid and arylsulfonic acid are present in a molar ratio ranging from 16:1 to 5:1. According to a preferred embodiment of the present invention, the sulfuric acid and arylsulfonic acid are present in a molar ratio ranging from 12:1 to 6:1. Also preferably, said arylsulfonic acid has a molecular weight below 300 g/mol. Also preferably, said arylsulfonic acid has a molecular weight below 150 g/mol. Even more preferably, said arylsulfonic acid is selected from the group consisting of: orthanilic acid; metanilic acid; sulfanilic acid; toluenesulfonic acid; benzenesulfonic acid; and combinations thereof.

According to preferred embodiment of the present invention, the modified Caro's acid (as disclosed in Canadian patent application 3,128,673) comprises: sulfuric acid; a heterocyclic compound; an alkanesulfonic acid; and wherein sulfuric acid and said a heterocyclic compound; are present in a molar ratio of no less than 1:1. Preferably, said aqueous acidic composition comprising: sulfuric acid; a heterocyclic compound; an arylsulfonic acid; and wherein sulfuric acid and said a heterocyclic compound; are present in a molar ratio of no less than 1:1. Preferably, the arylsulfonic acid is toluenesulfonic acid.

Preferably, the sulfuric acid, the heterocyclic compound and the alkanesulfonic acid are present in a molar ratio ranging from 28:1:1 to 2:1:1. More preferably, the sulfuric acid the heterocyclic compound and the alkanesulfonic acid are present in a molar ratio ranging from 24:1:1 to 3:1:1. Preferably, the sulfuric acid, the heterocyclic compound and the alkanesulfonic acid are present in a molar ratio ranging from 20:1:1 to 4:1:1. More preferably, the sulfuric acid, the heterocyclic compound and the alkanesulfonic acid are present in a molar ratio ranging from 16:1:1 to 5:1:1. According to a preferred embodiment of the present invention, the sulfuric acid and heterocyclic compound are present in a molar ratio ranging from 12:1:1 to 6:1:1. Also preferably, said heterocyclic compound has a molecular weight below 300 g/mol. Also preferably, said heterocyclic compound has a molecular weight below 150 g/mol. Even more preferably, said heterocyclic compound is selected from the group consisting of: imidazole; triazole; n-methylimidazole; and combinations thereof. Preferably, the alkanesulfonic acid is selected from the group consisting of:
alkylsulfonic acids where the alkyl groups range from C1-C6 and are linear or branched; and combinations thereof. Preferably, said alkylsulfonic acid is selected from the group consisting of:
methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkylsulfonic acid is methanesulfonic acid.

According to preferred embodiment of the present invention, the modified Caro's acid (as disclosed in Canadian patent application 3,128,672) comprises: sulfuric acid; a carbonyl-containing nitrogenous base compound; and wherein sulfuric acid and said a carbonyl-containing nitrogenous base compound; are present in a molar ratio of no less than 1:1. According to a preferred embodiment of the present invention, the carbonyl-containing nitrogenous base compound is selected from the group consisting of: caffeine; lysine; creatine; glutamine; creatinine; 4-aminobenzoic acid; glycine; NMP (N-methyl-2-pyrrolidinone); histidine; DMA (N,N-dimethylacetamide); arginine; 2,3-pyridinedicarboxylic acid; hydantoin; and combinations thereof. Preferably, the sulfuric acid and said carbonyl-containing nitrogenous base compound and are present in a molar ratio ranging from 28:1 to 2:1. More preferably, the sulfuric acid and carbonyl-containing nitrogenous base compound are present in a molar ratio ranging from 24:1 to 3:1. Preferably, the sulfuric acid and carbonyl-containing nitrogenous base compound are present in a molar ratio ranging from 20:1 to 4:1. More preferably, the sulfuric acid and carbonyl-containing nitrogenous base compound are present in a molar ratio ranging from 16:1 to 5:1. According to a preferred embodiment of the present invention, the sulfuric acid and carbonyl-containing nitrogenous base compound are present in a molar ratio ranging from 12:1 to 6:1.

According to a preferred embodiment of the present invention, said lignocellulosic biomass comprising lignin, hemicellulose and cellulose is exposed to a modified Caro's acid composition having a pH of less than 1, said modified Caro's acid composition selected from the group consisting of: composition A; composition B; composition C; composition D; composition E; composition F; composition G; composition H; composition I; and composition J;

wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1.

According to a preferred embodiment of the present invention, the lignocellulosic biomass mixture comprising hemicellulose, lignin, and cellulose is exposed to a modified Caro's acid composition at a temperature and for a period of time sufficient to a delignification reaction to occur and remove over 95 wt % of said lignin and over 70% of the hemicellulose in a liquid stream preferably leaving in solid form most of the cellulose from said biomass. Preferably, the liquid stream is removed upon completion of the delignification reaction for further processing into biofuel or fine chemicals. It is highly desirable to improve the separation of the various constituents in such a way as to increase the percent concentration of the targeted constituent (be it cellulose, hemicellulose, lignin) depending on the treatment step. In a delignification step using a modified Caro's acid where the sulfuric acid content is above 40%, approximately 85% of the hemicellulose initially present in the biomass, will be removed during the delignification step and will be present with the lignin-derived products. When performing a delignification of the biomass according to a preferred embodiment of the present invention, it is estimated that up to 90% of the hemicellulose initially present in the biomass will be dissolved during the delignification step and will end up intermixed with the lignin derived products.

Preferably, said compound comprising an amine moiety and a sulfonic acid moiety is selected from the group consisting of taurine; taurine derivatives; and taurine-related compounds.

Preferably, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates as well as aminoalkylsulfonic acids, where the alkyl is selected from the group consisting of C₁-C₅ linear alkyl and C₁-C₅ branched alkyl. Preferably, said linear alkylaminosulfonic acid is selected from the group consisting of: methyl; ethyl (taurine); propyl; and butyl. Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and a compound comprising an amine moiety and a sulfonic acid moiety are present in a molar ratio of no less than 3:1.

According to a preferred embodiment of the present invention, said compound comprising an amine moiety is an alkanolamine is selected from the group consisting of: monoethanolamine; diethanolamine; triethanolamine; and combinations thereof.

Preferably, said compound comprising a sulfonic acid moiety is selected from the group consisting of: alkylsulfonic acids; arylsulfonic acids; and combinations thereof. Preferably, said alkylsulfonic acid is selected from the group consisting of: alkylsulfonic acids where the alkyl groups range from C₁-C₆ and are linear or branched; and combinations thereof. More preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. According to a preferred embodiment of the present invention, said arylsulfonic acid is selected from the group consisting of: toluenesulfonic acid; benzesulfonic acid; and combinations thereof.

According to a preferred embodiment of the present invention, the temperature of the lignocellulosic biomass mixture comprising hemicellulose, lignin and cellulose is kept below 55° C. for the duration of the delignification reaction. Preferably, the temperature of the lignocellulosic biomass mixture comprising hemicellulose, lignin and cellulose is kept below 50° C. for the duration of the delignification reaction. According to another preferred embodiment of the present invention, the temperature of the lignocellulosic biomass mixture comprising hemicellulose, lignin and cellulose is kept below 45° C. for the duration of the delignification reaction. According to a preferred embodiment of the present invention, the temperature of the lignocellulosic biomass mixture comprising hemicellulose, lignin and cellulose is kept below 40° C. for the duration of the delignification reaction.

According to a preferred embodiment of the present invention, the temperature of the remaining biomass mixture is controlled throughout the delignification reaction to subsequent additions of a solvent (water) to progressively lower the slope of temperature increase per minute from less than 1° C. per minute to less than 0.5° C. per minute.

According to another preferred embodiment of the present invention, the temperature of the lignocellulosic biomass mixture comprising hemicellulose, lignin and cellulose is controlled by an addition of a solvent (water) to reduce the slope of temperature increase per minute of the reaction mass to less than 1° C. per minute.

According to yet another preferred embodiment of the present invention, the temperature of the lignocellulosic biomass mixture comprising hemicellulose, lignin and cellulose is controlled by a second addition of a solvent (water) to reduce the slope of temperature increase per minute of the reaction mass to less than 0.7° C. per minute.

Preferably, the temperature of the lignocellulosic biomass mixture comprising hemicellulose, lignin and cellulose is controlled by a third addition of a solvent (water) to reduce the slope of temperature increase per minute of the reaction mass to less than 0.3° C. per minute.

Preferably, the temperature of the lignocellulosic biomass mixture comprising hemicellulose, lignin and cellulose is controlled by a fourth addition of a solvent (water) to reduce the slope of temperature increase per minute of the reaction mass to less than 0.1° C. per minute.

According to a preferred embodiment of the present invention, the kappa number of the resulting cellulose is below 10, preferably it is below 5.

According to a preferred embodiment of the present invention, there is provided a process to delignify biomass using an aqueous acidic composition comprising:
sulfuric acid;
a heterocyclic compound; and
a peroxide.

According to another preferred embodiment of the present invention, there is provided a process to delignify biomass using an aqueous acidic composition comprising:
sulfuric acid;
a heterocyclic compound; and
   wherein sulfuric acid and said a heterocyclic compound; are present in a molar ratio of no less than 1:1.

Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. According to a preferred embodiment of the present invention, the sulfuric acid and heterocyclic compound are present in a molar ratio ranging from 12:1 to 6:1.

Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to an aspect of the present invention, there is provided a process to delignify biomass, such as wood using an aqueous acidic composition comprising:
sulfuric acid;
a heterocyclic compound; and
a peroxide.
   wherein the sulfuric acid and the heterocyclic compound are present in a mole ratio ranging from 2:1 to 28:1.

Preferably, said sulfuric acid, said compound comprising an amine moiety and a sulfonic acid moiety and said peroxide are present in a molar ratio of no less than 1:1:1. Also preferably, said sulfuric acid, said compound comprising an amine moiety and a sulfonic acid moiety and said peroxide are present in a molar ratio of no more than 15:1:1.

According to a preferred embodiment of the present invention, said sulfuric acid and said compound comprising an amine moiety and a sulfonic acid moiety are present in a molar ratio of no less than 3:1.

According to a preferred embodiment of the present invention, said compound comprising an amine moiety and a sulfonic acid moiety is selected from the group consisting of: taurine; taurine derivatives; and taurine-related compounds.

According to a preferred embodiment of the present invention, said taurine derivative or taurine-related compound is selected from the group consisting of: taurolidine; taurocholic acid; tauroselcholic acid; tauromustine; 5-taurinomethyluridine and 5-taurinomethyl-2-thiouridine;

homotaurine (tramiprosate); acamprosate; and taurates; as well as aminoalkylsulfonic acids where the alkyl is selected from the group consisting of C₁-C₅ linear alkyl and C₃-C₅ branched alkyl. Preferably, said linear alkylaminosulfonic acid is selected from the group consisting of: methyl; ethyl (taurine); propyl; and butyl.

Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and a compound comprising an amine moiety and a sulfonic acid moiety are present in a molar ratio of no less than 3:1.

According to a preferred embodiment of the present invention, said compound comprising an amine moiety is an alkanolamine is selected from the group consisting of: monoethanolamine; diethanolamine; triethanolamine; and combinations thereof.

According to a preferred embodiment of the present invention, said compound comprising a sulfonic acid moiety is selected from the group consisting of: alkylsulfonic acids and combinations thereof.

According to a preferred embodiment of the present invention, said alkylsulfonic acid is selected from the group consisting of: alkylsulfonic acids where the alkyl groups range from C₁-C₆ and are linear or branched; and combinations thereof.

According to a preferred embodiment of the present invention, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

According to a preferred embodiment of the present invention, said alkylsulfonic acid; and said peroxide is present in a molar ratio of no less than 1:1.

According to a preferred embodiment of the present invention, said compound comprising a sulfonic acid moiety is methanesulfonic acid.

According to a preferred embodiment of the present invention, in Composition C, said sulfuric acid and said a compound comprising an amine moiety and said compound comprising a sulfonic acid moiety are present in a molar ratio of no less than 1:1:1.

According to a preferred embodiment of the present invention, in Composition C, said sulfuric acid, said compound comprising an amine moiety and said compound comprising a sulfonic acid moiety are present in a molar ratio ranging from 28:1:1 to 2:1:1.

### DETAILED DESCRIPTION OF A PREFERRED EMBODIMENT OF THE INVENTION

According to a preferred embodiment of the present invention, there is provided a method for obtaining alpha cellulose in a purity of above 90%.

It is to be understood that “lignocellulosic material” includes any type of lignocellulosic material comprising cellulose, such as but not limited to non-woody-plant lignocellulosic material, wooden material, agricultural wastes, forestry residues, paper-production waste or by-products, nut shells, and the like.

According to a preferred embodiment of the present invention, the lignocellulosic material can include, but is not limited to agricultural exploitation by-products including but not limited to rice straw, rice hulls, barley straw, corn cobs, wheat straw, canola straw, oat straw, oat hulls, and corn fiber; stover, selected from but not limited to soybean stover, corn stover; grass, selected from but not limiting to switch grass, cord grass, rye grass, reed canary grass, miscanthus, or a combination thereof; sugar-processing by-products including but not limited to sugar cane bagasse; nuts and the like including but not limited to walnut shells, peanut shells, olive pits, pistachio shells, or a combination thereof; as well as forest industry by-products including but not limited to recycled wood pulp fiber, sawdust, hardwood, softwood, or any combination thereof.

According to a preferred embodiment of the present invention, there is provided a process for obtaining alpha-cellulose with high molecular weight and purity. Alpha-cellulose is understood to be the cellulose fraction which is insoluble in a 17.5% caustic solution (at 20° C.). Beta-cellulose is understood to be the cellulose fraction which is soluble in a 17.5% caustic solution (at 20° C.) which can subsequently be reprecipitated by acidification. Compared to alpha cellulose, it contains a lower degree of polymerization.

According to a preferred embodiment of the present invention, there is provided a process for the delignification of lignocellulosic biomass at temperature sufficiently low (i.e., less than 45° C.) to preserve as much native alpha cellulose as possible. Preferably, the temperature of the delignification mixture is less than 40° C. Preferably, the temperature of the delignification mixture is less than 35° C.

The increased yield of the process according to a preferred embodiment of the present invention is due to the fact the delignification process is highly selective and yields the native cellulose in a very high percentage.

An advantage of a preferred embodiment of the present invention is that there are no conventional bleaching steps employed, which means that the cost of the process to obtain the cellulose is substantially lower and significantly more environmentally conscious than any other process to generate alpha cellulose at a purity above 90%.

It was determined that on the basis of varying delignification process temperatures that alpha cellulose was obtained in greater yields from delignification experiments which were carried out at a temperature of 35° C.

Alpha-cellulose with high molecular weight and purity can be readily converted into high end products like cellulose derivatives including microcrystalline cellulose, dissolving pulp, nanocrystalline cellulose, that serve as starting materials for the production of plastics and other polymeric materials. Additionally, the hemicellulose (as xylose and other decomposition products) and lignin obtained by the process of the present invention can be further converted into industrially useful products, rendering the process commercially cost effective.

Thus, the process according to a preferred embodiment of the present invention is extremely useful for effective utilization of natural resources and waste material and converting them into high demand high value commodities.

### Experiment #1

### Delignification

The following experimentation was conducted using canola straw as the biomass feedstock. The canola straw was characterized to determine the content of acid-insoluble lignin (also known as Klason lignin) as well as carbohydrate composition. The carbohydrate composition gives an indication of cellulose and hemicellulose distribution within the biomass. Results of the characterization of the canola straw are shown in Table 1.

TABLE 1
Results of the characterization of canola
straw used in the experiments

| Parameter | Units | Result |
|---|---|---|
| Klason lignin | %, OD basis | 16.1% |
| Arabinan | %, extracted OD basis | 1.2% |
| Xylan | %, extracted OD basis | 11.6% |
| Mannan | %, extracted OD basis | 1.0% |
| Galactan | %, extracted OD basis | 1.1% |
| Glucan | %, extracted OD basis | 25.3% |

The canola biomass was exposed to a delignification reaction according to the method described herein at different temperatures. A H₂SO₄:H₂O₂:taurine:water blend with a 10:10:1:17 molar ratio was prepared in a reactor by mixing 1169.5 g of concentrated sulfuric acid (93%), 143.3 g of the modifier, 1342.7 g of hydrogen peroxide (29%), and 344.5 g of water. As the mixing releases a large amount of heat, the reactor was refrigerated. The pH of the resulting composition was less than 0.5. The canola sample was then added into each of the blends as 3% wt. solids loading (90 g). The reaction was left stirring at the different temperatures for 3 hours, after which the solids were extracted from the liquid and a yield of the solids was obtained.

Table 2 shows the yield of solid cellulose for the delignification reactions of canola at different temperatures as % of the initial biomass, the hydrogen peroxide consumption for each delignification reaction as % of the cellulose solids recovered as well as the Kappa number of the cellulose obtained from each delignification reaction.

TABLE 2
Blend compositions, cellulose yields, and hydrogen peroxide
consumptions of the reactions described in Experiment 1

| | | H₂O₂ | | |
|---|---|---|---|---|
| | Cellulose yield | consumption | | |
| Temperature | (% of | (g/g | Kappa | Lignin (% |
| (° C.) | biomass) | cellulose) | number | wt.) |
| 30 | 42.7% | 0.53 | 4.3 | 0.56 |
| 35 | 31.7% | 0.74 | 3.6 | 0.47 |
| 40 | 41.6% | 0.64 | 2.8 | 0.36 |
| 45 | 41.3% | 1.09 | 2.1 | 0.27 |

Table 2 shows that as the temperature increases, the yield of cellulose solids stays quite consistent with a decrease in Kappa number. This is expected as a higher temperature will promote more degradation and increased removal of the lignin portion into the liquid stream. Additionally, a higher peroxide consumption is observed with temperature as the reaction becomes more aggressive. Table 3 shows the characterization of the cellulose obtained from the delignification reactions of canola biomass at temperatures of 30° C., 35° C., 40° C., and 45° C.

TABLE 3
Cellulose characterization parameters of the delignification
of canola biomass at different temperatures

| Parameter | 30° C. | 35° C. | 40° C. | 45° C. |
|---|---|---|---|---|
| Hemicellulose content (%) | 11.1 | 11.8 | 11.5 | 9.4 |
| Cellulose content (%) | 88.9 | 88.2 | 88.2 | 88.5 |
| Alpha-cellulose content | 97.1 | 87.6 | 89.4 | 72.5 |
| (%) | | | | |
| Beta-cellulose content | 2.9 | 12.4 | 10.6 | 27.5 |
| (%)* | | | | |

*Beta-cellulose error data ranges between 2 and 4% because it had to reprecipitate and filter and re-precipitate for hemicellulose thereby increasing the measurement error.

Table 3 shows that as the delignification temperature increased, the hemicellulose content decreases slightly as more hemicellulose will be degraded into the liquid portion with a more aggressive delignification. More interestingly, the remaining cellulose content has a decreasing amount of alpha-cellulose (undegraded, high molecular weight cellulose) as the temperature of the reaction increases. This is again due to the reaction becoming more aggressive on the high molecular weight cellulose and cleaving it through the amorphous regions, that are more susceptible to attack. This is observed as the beta-cellulose content (more degraded, low molecular weight cellulose) increases with temperature.

It is known to those skilled in the art, that alpha-cellulose is characterized by long, undegraded chains of cellulose with a higher degree of polymerization; whereas beta-cellulose is referred to the cellulose that is short-chained and with a lower degree of polymerization. This indicates that, as expected, as the reaction temperature increases, the rate of decomposition of the cellulose increases; thus, yielding a more degraded cellulose (i.e. shorter chains of cellulose).

### Experiment #2

### Delignification

The following experimentation was conducted using hardwood as the biomass feedstock. The hardwood was characterized to determine the content of acid-insoluble lignin (also known as Klason lignin) as well as carbohydrate composition. The carbohydrate composition gives an indication of cellulose and hemicellulose distribution within the biomass. Results of the characterization of the hardwood are shown in Table 4.

TABLE 4
Results of the characterization of
hardwood used in the experiments

| Parameter | Units | Result |
|---|---|---|
| Klason lignin | %, OD basis | 19.8% |
| Arabinan | %, extracted OD basis | 0.2% |
| Xylan | %, extracted OD basis | 17.9% |
| Mannan | %, extracted OD basis | 1.3% |
| Galactan | %, extracted OD basis | 0.3% |
| Glucan | %, extracted OD basis | 43.6% |

The hardwood biomass was exposed to a delignification reaction according to the method described herein at different temperatures. A H₂SO₄:H₂O₂:taurine:water blend with a 10:10:1:17 molar ratio was prepared in a reactor by mixing 1169.5 g of concentrated sulfuric acid (93%), 143.3 g of the modifier, 1342.7 g of hydrogen peroxide (29%), and 344.5 g of water. As the mixing releases a large amount of heat, the reactor was refrigerated. The pH of the resulting composition was less than 0.5. The hardwood sample was then added into each of the blends as 3% wt. solids loading (90 g). The reaction was left stirring at the different temperatures for 3 hours, after which the solids were extracted from the liquid and a yield of the solids was obtained.

Table 5 shows the yield of solid cellulose for the delignification reactions of hardwood at different temperatures as % of the initial biomass, the hydrogen peroxide consumption for each delignification reaction as % of the cellulose solids recovered as well as the Kappa number of the cellulose obtained from each delignification reaction.

TABLE 5
Blend compositions, cellulose yields, and hydrogen peroxide
consumptions of the reactions described in Experiment 2

| | | H₂O₂ | | |
|---|---|---|---|---|
| | Cellulose yield | consumption | | |
| Temperature | (% of | (g/g | Kappa | Lignin (% |
| (° C.) | biomass) | cellulose) | number | wt.) |
| 30 | 64.6% | 0.25 | 2.7 | 0.35 |
| 35 | 59.5% | 0.55 | 1.9 | 0.25 |
| 40 | 53.7% | 0.59 | 1.4 | 0.19 |
| 45 | 48.5% | 0.94 | 1.4 | 0.19 |

The results in Table 5 indicate that, as the temperature decreases, the cellulose yield increases and so does the Kappa number. This is not unexpected since as the temperature is reduced, the reactivity of the modified Caro's acid decreases, thus leading to a less complete or efficient delignification. This is further evidenced by the increase in cellulose yield and the increase in Kappa number, which indicates that more lignin and hemicellulose is left behind with the solids. Table 6 shows the characterization of the cellulose obtained from each reaction.

TABLE 6
Cellulose solids yield and cellulose characterization
parameters of the delignification of canola biomass
at different temperatures, 35 and 45° C.

| Parameter | 30° C. | 35° C. | 40° C. | 45° C. |
|---|---|---|---|---|
| Hemicellulose content (%) | 7.1 | 7.6 | 8.3 | 7.3 |
| Cellulose content (%) | 92.9 | 92.4 | 91.7 | 92.7 |
| Alpha-cellulose content | 94.2 | 93.4 | 91.7 | 92.0 |
| (%) | | | | |
| Beta-cellulose content | 5.8 | 6.6 | 8.3 | 8.0 |
| (%) | | | | |

Table 6 shows that as the delignification temperature increased, the alpha-cellulose content decreased and as a result, the beta-cellulose content increased, confirming the effect observed in Experiment 1. It is important to note that the effect observed will vary in significance based on the biomass feedstock. As it should be known by those skilled in the art, not all biomasses comprise the same amount of cellulose and the cellulose component of different biomasses show different degrees of polymerization, molecular weights and crystallinity differences that will impact the results of this experimentation. It is likely that biomasses with higher cellulose crystallinity and longer molecular weight will suffer less of an impact than more degraded cellulose-containing biomasses.

It is known by those skilled in the art that different types of cellulose will be more suitable for different applications. As an example, for the manufacturing of microcrystalline cellulose for pharmaceutical and food applications, a high alpha-cellulose content is desired; however, more degraded, short-chain cellulose might be beneficial for applications where the degradation of cellulose is sought after (i.e., generation of biofuels). As dissolving pulp is one of the potential products using a preferred process of the present invention, performing the delignification at a pre-determined temperature using a modified Caro's acid as described herein allows one to maximize the output of alpha cellulose.

It is known by those skilled in the art that different types of cellulose will be more suitable for different applications. As a way of example, for the manufacturing of microcrystalline cellulose (MCC) for pharmaceutical and food applications, a high alpha-cellulose content is desired. Herein, alpha-cellulose refers to an undegraded, long-chain cellulose. Other applications where a high alpha-cellulose is desired include dissolving pulp for textile applications as well as to manufacture nitrocellulose, which is used in commonly in explosives, coatings, inks and other industrial and medical applications.

On the other hand, more degraded, short-chain cellulose, referred to herein as beta-cellulose, is beneficial for applications where the degradation of cellulose is sought-after. Some of these processes include but are not limited to cellulose hydrolysis to sugars and organic acids, conversion to platform chemicals (i.e., furan-derivatives and other biobased chemicals, etc.) as well as hydrolysis and fermentation processes into high value-added chemicals such as alcohols, vitamins, acids, etc.

It is then clear how being able to obtain a high alpha or high beta cellulose by altering the temperature conditions of the delignification using a modified Caro's acid (as disclosed herein) is an important aspect that makes the process extremely valuable because of its versatility and because of its low-cost, a low-energy alternative to other conventional processes.

As another aspect of the present invention, there is provided a method to generate a specific type of cellulose in terms of its predominant morphology (alpha vs beta) based on the temperature at which the delignification of the biomass occurs.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A method for obtaining alpha-cellulose in a purity of above 85%, where said method comprises the following steps:
Step 1: providing a biomass feedstock comprising: cellulose; hemicellulose; and
lignin;
Step 2: exposing the biomass feedstock to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
wherein said composition C comprises:
an alkylsulfonic acid; and
a peroxide; wherein said alkylsulfonic acid and said peroxide are present in a molar ratio of no less than 1:1;
wherein said composition D comprises:
sulfuric acid;
a heterocyclic compound; and
a peroxide; and wherein sulfuric acid and said a heterocyclic compound; are present in a molar ratio of no less than 1:1;
wherein said composition E comprises:
sulfuric acid;
a modifying agent comprising a compound containing an amine group; and
a peroxide; and wherein sulfuric acid and said compound containing an amine group; are present in a molar ratio of no less than 1:1;
wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
wherein said composition G comprises:
sulfuric acid;
a substituted aromatic compound; and
a peroxide; and wherein sulfuric acid and said substituted aromatic compound; are present in a molar ratio of no less than 1:1;
wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
wherein said delignification is carried out at a temperature ranging 20-40° C. for a period of time sufficient to allow the modified Caro's acid to delignify said lignocellulosic biomass and yield: a remaining solids portion having a kappa number of less than 10; and a liquid stream;
Step 4: removing said liquid stream comprising depolymerized lignin and depolymerized hemicellulose from the resulting reaction mixture;
Step 5: recovering said remaining solids portion comprising high purity cellulosic portion.

2. The method according to claim 1, where said temperature ranges between 25 and 35° C.

3. The method according to claim 1, wherein Step 4 is followed by:
a step of exposing said remaining solids portion to a caustic composition at a low temperature to generate a caustic mixture comprising said caustic composition, hemicellulose, alpha-cellulose, and beta-cellulose;
followed by a step of allowing sufficient time for said caustic composition to dissolve said hemicellulose and beta cellulose present in said remaining solids portion and yield a high purity cellulosic portion comprising a high 90% of alpha cellulose in a reacted caustic mixture; and
optionally, followed by a step of extracting said dissolved hemicellulose as well as beta-cellulose from said reacted caustic mixture; and
a step of recovering said high purity cellulosic portion.

4. The method according to claim 3, wherein the removal of beta-cellulose from said reacted caustic mixture comprises altering the pH of said reacted caustic mixture to a pH between 2-6 and removing the resulting precipitated beta-cellulose therefrom.

5. The method according to claim 3, wherein the removal of hemicellulose from said reacted caustic mixture comprises adding to said alkali solution a sufficient amount of a solvent consisting essentially of ethanol to precipitate said hemicellulose from said caustic alkali solution, removing the resulting precipitated hemicellulose from the caustic solution.

6. The method according to claim 3, wherein the caustic composition is recovered and purified.

7. The method according to claim 3, wherein the temperature at which the caustic exposure occurs does not exceed 60° C.

8. The method according to claim 3, where the cellulose has a fiber length of 100 to 1000 microns.

9. The method according to claim 3, wherein said alpha-cellulose accounts for over 70% of the cellulose obtained.

10. The method according to claim 3, wherein said delignification step is carried out at a temperature ranging from 25 to 35° C.

11. The method according to claim 3, wherein said delignification step is carried out at a temperature ranging from 30 to 35° C.

12. A method for obtaining alpha-cellulose in a purity of above 90%, where said method comprises the following steps:
Step 1: providing a biomass feedstock comprising: cellulose; hemicellulose; and lignin;
Step 2: exposing said biomass feedstock to a first acidic composition comprising an acid selected from the group consisting of: mineral acids; organic acids; modified acids; synthetic acids; and combinations thereof; for a first period of time sufficient to dissolve at least 50% of the hemicellulose present in said biomass feedstock;
Step 3: separating and recovering into a first liquid stream comprising dissolved hemicellulose from a remaining lignocellulosic biomass;
Step 4: exposing said remaining lignocellulosic biomass to a delignification step performed using a modified Caro's acid creating a reaction mixture, where said modified Caro's acid is selected from the group consisting of: composition A; composition B; composition C; composition D; composition E; composition F; composition G; composition H; composition I; and composition J;
wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
wherein said composition C comprises:
an alkylsulfonic acid; and
a peroxide; wherein said alkylsulfonic acid and said peroxide are present in a molar ratio of no less than 1:1;
wherein said composition D comprises:
sulfuric acid;
a heterocyclic compound; and
a peroxide; and wherein sulfuric acid and said a heterocyclic compound; are present in a molar ratio of no less than 1:1;
wherein said composition E comprises:
sulfuric acid;
a modifying agent comprising a compound containing an amine group; and
a peroxide; and wherein sulfuric acid and said compound containing an amine group; are present in a molar ratio of no less than 1:1;
wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
wherein said composition G comprises:
sulfuric acid;
a substituted aromatic compound; and
a peroxide; and wherein sulfuric acid and said substituted aromatic compound;
are present in a molar ratio of no less than 1:1;
wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
wherein said delignification step is carried out at a temperature ranging from 20-40° C. for a period of time sufficient to allow the modified Caro's acid to delignify said remaining lignocellulosic biomass and yield;
a high purity cellulosic portion having a kappa number of less than 10; and
a liquid stream;
Step 4:
removing said liquid stream comprising depolymerized lignin and depolymerized hemicellulose from the resulting reaction mixture;
Step 7: recovering said high purity cellulosic portion;
wherein said high purity cellulosic portion comprises no less than 90% alpha cellulose and no more than 1% lignin and no more than 5% hemicellulose.

13. The method according to claim 12, wherein said delignification step is carried out at a temperature ranging from 25 to 35° C.

14. The method according to claim 12, wherein said delignification step is carried out at a temperature ranging from 30 to 35° C.

15. A method for obtaining beta-cellulose in a yield of ranging up to 50% of all cellulose comprised in a biomass feedstock, where said method comprises the following steps:
Step 1: providing a biomass feedstock comprising: cellulose; hemicellulose; and lignin;
Step 2: exposing the biomass feedstock to a delignification step performed using a modified Caro's acid creating a reaction mixture, where said modified Caro's acid is selected from the group consisting of: composition A; composition B; composition C;
composition D; composition E; composition F; composition G; composition H;
composition I; and composition J;
wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
wherein said composition C comprises:
an alkylsulfonic acid; and
a peroxide; wherein said alkylsulfonic acid and said peroxide are present in a molar ratio of no less than 1:1;
wherein said composition D comprises:
sulfuric acid;
a heterocyclic compound; and
a peroxide; and wherein sulfuric acid and said a heterocyclic compound; are present in a molar ratio of no less than 1:1;
wherein said composition E comprises:
sulfuric acid;
a modifying agent comprising a compound containing an amine group; and
a peroxide; and wherein sulfuric acid and said compound containing an amine group; are present in a molar ratio of no less than 1:1;
wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
wherein said composition G comprises:
sulfuric acid;
a substituted aromatic compound; and
a peroxide; and wherein sulfuric acid and said substituted aromatic compound;
are present in a molar ratio of no less than 1:1;
wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
wherein said delignification is carried out at a temperature ranging from 40-70° C. for a period of time sufficient to allow the modified Caro's acid to delignify said lignocellulosic biomass and yield:
a remaining solids portion having a kappa number of less than 10; and
a liquid stream;
Step 4: removing said liquid stream comprising depolymerized lignin and depolymerized hemicellulose from the resulting reaction mixture;
Step 5: recovering said remaining solids portion comprising a high purity cellulosic portion.

16. A method according to claim 15, wherein said high purity cellulosic portion comprises between 10 and 30% of beta cellulose.

17. The method according to claim 15, wherein said delignification step is carried out at a temperature ranging from 40 to 55° C.

18. The method according to claim 15, wherein Step 4 is followed by:
a step of exposing said remaining solids portion to a caustic composition at a low temperature to generate a caustic mixture comprising said caustic composition, hemicellulose, alpha-cellulose, and beta-cellulose;
followed by a step of allowing sufficient time for said caustic composition to dissolve said hemicellulose and beta cellulose present in said remaining solids portion and yield a high purity cellulosic portion; and
optionally, followed by a step of extracting said dissolved beta-cellulose from said reacted caustic mixture wherein said beta-cellulose is at least 50% pure.
